(19) United States
(12) Patent Application Publication
(10) Pub. No.: US 2011/0013575 A1
(43) Pub. Date: Jan. 20, 2011

(54) METHOD OF GENERATING PREAMBLE SEQUENCE FOR WIRELESS LOCAL AREA NETWORK SYSTEM AND DEVICE THEREOF

(76) Inventors: Yen-Chin Liao, Taipei City (TW); Cheng-Hsuan Wu, Taipei City (TW); Yung-Szu Tu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/835,752

(22) Filed: Jul. 14, 2010

Related U.S. Application Data
(60) Provisional application No. 61/225,931, filed on Jul. 16, 2009.

(30) Foreign Application Priority Data
Dec. 1, 2009 (TW) 098141064

(51) Int. Cl. H04W 8/00; H04L 29/02

(52) U.S. Cl. 370/329; 370/476

(57) ABSTRACT

A method of generating a preamble sequence includes generating a first frequency-domain preamble sequence according to information of the packet, the first frequency-domain preamble sequence comprising a plurality of subsequences corresponding to a plurality of sub-channels, adjusting a phase of each subsequence of the first frequency-domain preamble sequence, for generating a second frequency-domain preamble sequence, transforming the second frequency-domain preamble sequence into a first time-domain preamble sequence, performing a cyclic shift delaying process on the first time-domain preamble sequence, for generating a plurality of delayed time-domain preamble sequences, and normalizing power of the plurality of delayed time-domain preamble sequences, for generating a second time-domain preamble sequence that is a preamble sequence of the packet.

### CROSS REFERENCE TO RELATED APPLICATIONS

This application claims the benefit of U.S. Provisional Application No. 61/225,931, filed on Jul. 16, 2009 and entitled “WIRELESS TRANSMISSION METHOD AND DEVICE USING THE SAME”, the contents of which are incorporated herein.

### BACKGROUND OF THE INVENTION

1. Field of the Invention

The present invention relates to a method of generating a preamble sequence and device thereof, and more particularly, to a method of generating a preamble sequence for an IEEE 802.11n wireless local area network system and device thereof.

2. Description of the Prior Art

Wireless local area network (WLAN) technology is one of popular wireless communication technologies, which is developed for military use in the beginning and in recent years, is widely implemented in consumer electronics, e.g. desktop computers, laptop computers, personal digital assistants, etc., to provide the masses with a convenient and high-speed internet communication. IEEE 802.11 is a set of standards carrying out wireless local area network created by the Institute of Electrical and Electronics Engineers, including the former IEEE 802.11a/b/g standard and the current IEEE 802.11n standard. IEEE 802.11a/g/n standard use orthogonal frequency division multiplexing (OFDM) method to realize the air interface, and different from IEEE 802.11a/g standard, IEEE 802.11n standard is further improved by adding a multiple-input multiple-output (MIMO) technique and other features that greatly enhances data rate and throughput. In addition, in IEEE 802.11n standard the channel bandwidth is doubled from 20 MHz to 40 MHz.

Please refer to FIG. 1, which is a diagram of an IEEE 802.11n packet structure according to the prior art. An IEEE 802.11n packet consists of a preamble portion in the front of a packet and a payload portion after the preamble portion, carrying data to be transmitted. An IEEE 802.11n preamble is a mixed format preamble and is backward compatible with IEEE 802.11a/g standard devices, and includes legacy Short Training field (L-STF), legacy Long Training field (L-LTF), legacy Signal field (L-SIG), high-throughput Signal field (HT-SIG), high-throughput Short Training field (HT-STF), and high-throughput Long Training fields (HT-LTF). L-STF is used for start-of-packet detection, automatic gain control (AGC), initial frequency offset estimation, and initial time synchronization. L-LTF is used for further fine frequency offset estimation and time synchronization. L-SIG carries the data rate (which modulation and coding scheme is used) and length (amount of data) information. HT-SIG also carries data rate and length information, and is used for packet detection so that the mixed format or the legacy format the transmitted packet uses can be detected. HT-STF is used for automatic gain control. HT-LTF is used for MIMO channel detection.

According to the present IEEE 802.11n standard, the lower 20 MHz portion of the 40 MHz preamble is equal to the legacy, IEEE 802.11a/g 20 MHz preamble, and the upper 20 MHz portion of the 40 MHz preamble is a replica of the lower 20 MHz portion with a phase rotation of 90 degrees. The 90-degree rotation on the upper 20MHz portion is added in order to reduce peak-to-average power ratio (PAPR) when transmitting packets, and therefore the packet detection probability in a receiver is improved.

Please refer to FIG. 2, which is a functional block diagram of a transmitter 20 in a 4×4 wireless communication system according to the prior art. The transmitter 20 comprises a signal transforming unit 200, cyclic shift delay (CSD) processing units CSD_1-CSD_3, guard interval (GI) processing units GI_1-GI_4, radio frequency (RF) signal processing units RF_1-RF_4, and antennas A1-A4, wherein each CSD processing unit, GI processing unit, RF signal processing unit, and antenna on the same path compose a transmit chain. The signal transforming unit 200 is utilized for performing the inverse discrete Fourier transform to transform a frequency-domain sequence into a time-domain sequence, which is an OFDM symbol. A frequency-domain preamble sequence inputted to the signal transforming unit 200 can be a field whose value is fixed, such as L-STF, L-LTF, HT-STF, or HT-LTF, or can be a field already being through signal processing, such as L-SIG or HT-SIG.

As shown in FIG. 2, a frequency-domain preamble sequence Sₖ is transformed into a time-domain preamble sequence sₙ by the signal transforming unit 200, and the time-domain preamble sequence sₙ passes through a transmit chain including a CSD processing unit CSD_x for adding a cyclic prefix in order to resist multipath interference, a GI processing unit GI_x for adding an guard interval of 32 or 64 sampling time in order to avoid unintentional beamforming, and an RF signal processing unit RF_x for converting the processed time-domain preamble sequence into an RF signal, transmitted to the air by an antenna Ax.

For the achievement of a higher quality wireless LAN transmission, the IEEE committee creates an improved standard, IEEE 802.11ac, included in IEEE 802.11 VHT (Very High Throughput) standard. Compared to the channel bandwidth of 40 MHz in IEEE 802.11n standard, the channel bandwidth in IEEE 802.11ac standard is increased to 80 MHz. For backward compatibility of a preamble, one approach is duplicating the lower 40 Mz portion of an 80 MHz preamble with a phase rotation of 90 degrees to generate the upper 40 Mz portion, similar to the method used in IEEE 802.11n standard. However, large PAPR will be introduced in the 80 MHz preamble and degrades the signal quality. IEEE 802.11ac standard should not only provide backward compatibility but aims at higher quality packet transmission.

### SUMMARY OF THE INVENTION

It is therefore a primary objective of the claimed invention to provide a method of generating preamble sequence for a wireless local area network device.

The present invention discloses a method of generating a preamble sequence. The method of generating a preamble sequence includes generating a first frequency-domain preamble sequence according to information of the packet, the first frequency-domain preamble sequence comprising a plurality of subsequences corresponding to the plurality of sub-channels, adjusting a phase of each subsequence of the first frequency-domain preamble sequence, for generating a second frequency-domain preamble sequence, transforming the second frequency-domain preamble sequence into a first time-domain preamble sequence, performing a cyclic shift delaying process on the first time-domain preamble sequence, for generating a plurality of delayed time-domain preamble sequences, and normalizing power of the plurality of delayed time-domain preamble sequences, for generating a second time-domain preamble sequence that is a preamble sequence of the packet.

The present invention further discloses a wireless device that includes a sequence generating unit, a phase adjusting unit, a signal transforming unit, and a peak-to-average power ratio (PAPR) adjusting unit. The sequence generating unit is utilized for generating a first frequency-domain preamble sequence according to information of the packet, wherein the first frequency-domain preamble sequence comprises a plurality of subsequences corresponding to a plurality of sub-channels. The phase adjusting unit is utilized for adjusting a phase of each subsequence of the first frequency-domain preamble sequence, for generating a second frequency-domain preamble sequence. The signal transforming unit is utilized for transforming the second frequency-domain preamble sequence into a first time-domain preamble sequence. The PAPR adjusting unit is utilized for reducing the PAPR of the first time-domain preamble sequence, for generating a second time-domain preamble sequence that is a preamble sequence of the packet.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an IEEE 802.11n packet structure according to the prior art.

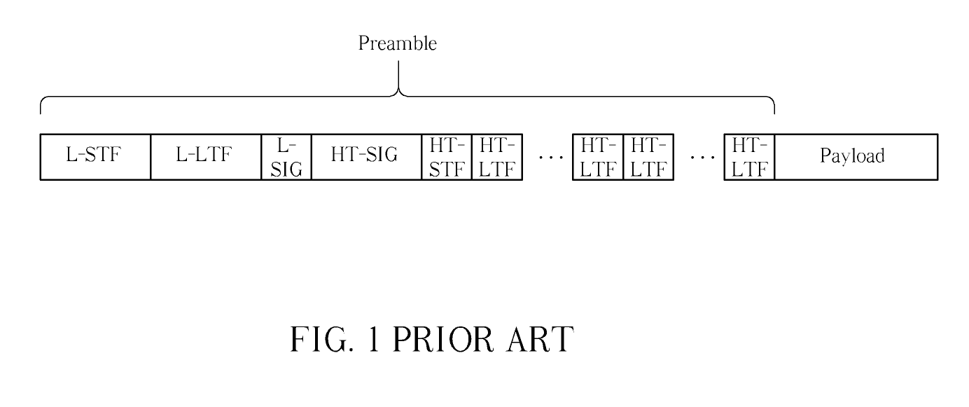

FIG. 2 is a functional block diagram of a transmitter in a 4×4 wireless communication system according to the prior art.

FIG. 3 is a functional block diagram of a transmitter in a 4×4 wireless communication system according to an embodiment of the present invention.

FIG. 4 is a diagram of an IEEE 802.11ac standard 80 MHz preamble sequence according to an embodiment of the present invention.

FIG. 5A is a diagram of the PAPR of a time-domain preamble sequence generated by a transmitter not including the PAPR adjusting unit shown in FIG. 3.

FIG. 5B is a diagram of the PAPR of a time-domain preamble sequence generated by a transmitter including the PAPR adjusting unit shown in FIG. 3.

FIG. 6 is a list of the minimum values of the packet detection probability under different SNR by each 40 MHz sub-channel and each transmit chain, measured by an auto-correlation detector of a 40 MHz receiver.

FIG. 7 is a list of the minimum values of the packet detection probability under different SNR by each 40 MHz sub-channel and each transmit chain, measured by a cross-correlation detector of a 40 MHz receiver.

FIG. 8 is a list of the minimum values of the packet detection probability under different SNR by each transmit chain, measured by an auto-correlation detector of an 80 MHz receiver.

FIG. 9 is a list of the minimum values of the packet detection probability under different SNR by each transmit chain, measured by a cross-correlation detector of an 80 MHz receiver.

FIG. 10 is a flowchart of a process according to an embodiment of the present invention.

### DETAILED DESCRIPTION

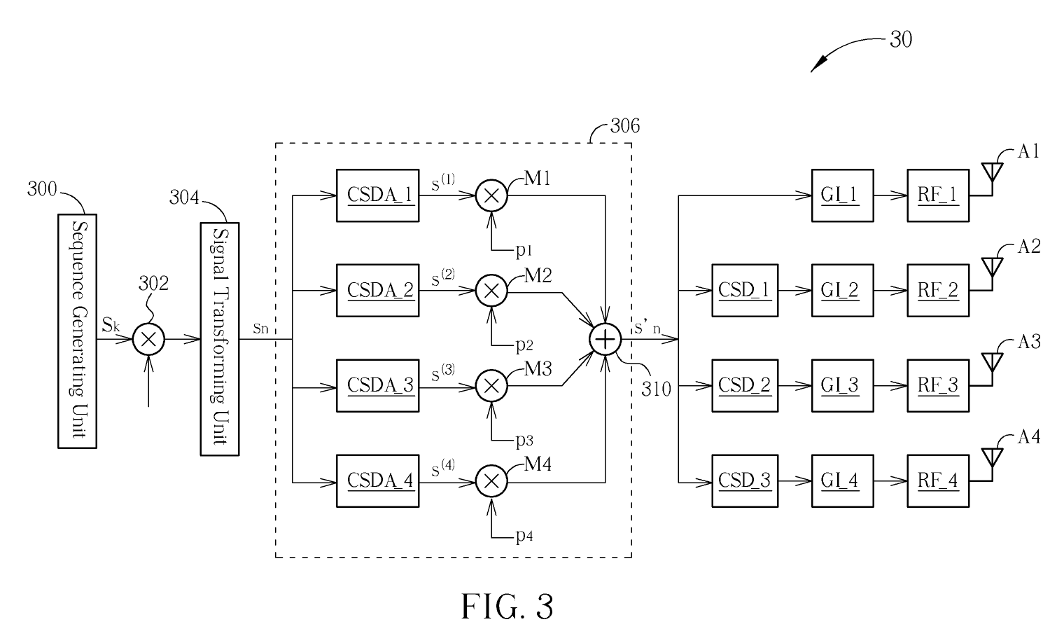

Please refer to FIG. 3, which is a functional block diagram of a transmitter 30 in a 4×4 wireless communication system according to an embodiment of the present invention. The transmitter 30 can be a wireless LAN card, access point, computer, and mobile communication device, such as mobile phone or personal digital assistant. The transmitter 30 comprises a sequence generating unit 300, a phase adjusting unit 302, a signal transforming unit 304, a peak-to-average power ratio (PAPR) adjusting unit 306, cyclic shift delay (CSD) processing units CSD_1-CSD_3, guard interval (GI) processing units GI_1-GI_4, radio frequency (RF) signal processing units RF_1-RF_4, and antennas A1-A4, wherein each CSD processing unit, GI processing unit, RF signal processing unit, and antenna compose a transmit chain.

The combination of the sequence generating unit 300, the phase adjusting unit 302, the signal transforming unit 304, and the PAPR adjusting unit 306 is also regarded as a time-domain preamble sequence generating device that is used to generate a time-domain preamble sequence as an OFDM symbol. The signal transforming unit 304 is utilized for transforming a frequency-domain preamble sequence into a time-domain preamble sequence. The PAPR adjusting unit 306 comprises CSD processing units CSDA_1-CSDA_4, multiplexers M1-M4, and an adder 310.

Note that, the 80 MHz channel in IEEE 802.11ac standard can be regarded as a combination of four 20 MHz sub-channels. The sequence generating unit 300 is utilized for generating an 80 MHz frequency-domain preamble sequence, hereafter called 80 MHz preamble sequence in short, wherein each of three 20 MHz preamble sequence corresponding to a higher sub-channel is a replica of a 20 MHz preamble sequence corresponding to the lowest sub-channel that is equal to the 20MHz preamble sequence of IEEE 802.11a/g standard. The 20 MHz channel in IEEE 802.11a/g standard is partitioned by 64 subcarriers and the overall 20 MHz preamble sequence is represented by {Sₖ: k=0, 1, . . . , 63}. Therefore, the 80 MHz preamble sequence generated by the sequence generating unit 300 is represented by {Sₖ=S_{k mod 64}, k=0, 1, . . . , 255}.

In an IEEE 802.11ac preamble, the value of L-STF, L-LTF, HT-STF or HT-LTF is fixed, and the IEEE 802.11a/g 20 MHz preamble sequence corresponding to the abovementioned fields are stored in a memory (not shown in FIG. 3) of the transmitter 30. The sequence generating unit 300 takes the 20 MHz preamble sequence corresponding to the abovementioned fields stored in the memory to generate a corresponding 80 MHz preamble sequence. In addition, since the value of L-SIG or HT-SIG is not fixed and indicates information about data rate and packet length, the 20 MHz preamble sequence corresponding to L-SIG or HT-SIG has to be processed through forward error correction (FEC) encoding, interleaving, and binary phase shift keying (BPSK) processes first then is outputted to the sequence generating unit 300. The signal processing on the L-SIG or HT-SIG is well-known to those skilled in the art and is not given herein.

The phase adjusting unit 302 is coupled to the sequence generating unit 300 and is an multiplexer in the embodiment of FIG. 3 to adjust phase of the 80 MHz preamble sequence, in detail, to adjust each of the higher three 20 MHz preamble sequences by a phase rotation of 90 degrees relative to a phase of its adjacent, lower 20 MHz preamble sequence. Therefore, the phase of each 20 MHz preamble sequence is 90-degree shifted relative to its adjacent, lower 20 MHz preamble. Compared to the lowest 20 MHz preamble sequences, the higher three 20 MHz preamble sequences are rotated by 90°, 180°, and 270° respectively. The phase rotation angles for the higher three 20 MHz preamble sequences are stored in a memory (not shown in FIG. 3) of the transmitter 30. The phase adjusting unit 302 obtains values of these phase rotation angles from the memory and thereby adjusts the phase of the 80 MHz preamble sequence generated by the sequence generating unit 300, so that each 20 MHz preamble sequence is with an appropriate phase. The 80 MHz preamble sequence outputted by the phase adjusting unit 302 is represented as

Sₖ₌(j)^{└k/64┘}S_{k mod 64}, k=0, 1, . . . , 255. (1)

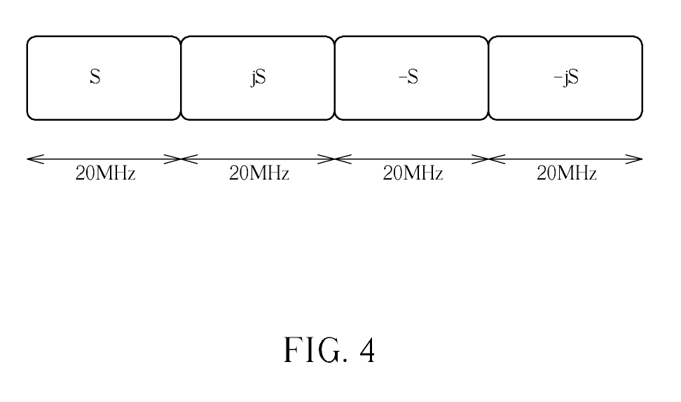

Please refer to FIG. 4, which is a diagram of an IEEE 802.11ac standard 80 MHz preamble sequence according to an embodiment of the present invention. The 80 MHz preamble sequence shown in FIG. 4 is generated by the phase adjusting unit 302. Let the lowest 20 MHz preamble sequence {Sₖ: k=0, 1, . . . , 63} be denoted as S, the total four 20 MHz preamble sequences are denoted as S, jS, -S, and -jS, as shown in FIG. 4. It is therefore known that the phase of each 20 MHz preamble sequence is rotated by 90° relative to the phase of its adjacent, lower 20 MHz preamble sequence. As a result, the 80 MHz preamble sequence shown in FIG. 4 is backward compatible to IEEE 802.11a/g standard using 20 MHz channel and IEEE 802.11n standard using 40 MHz channel.

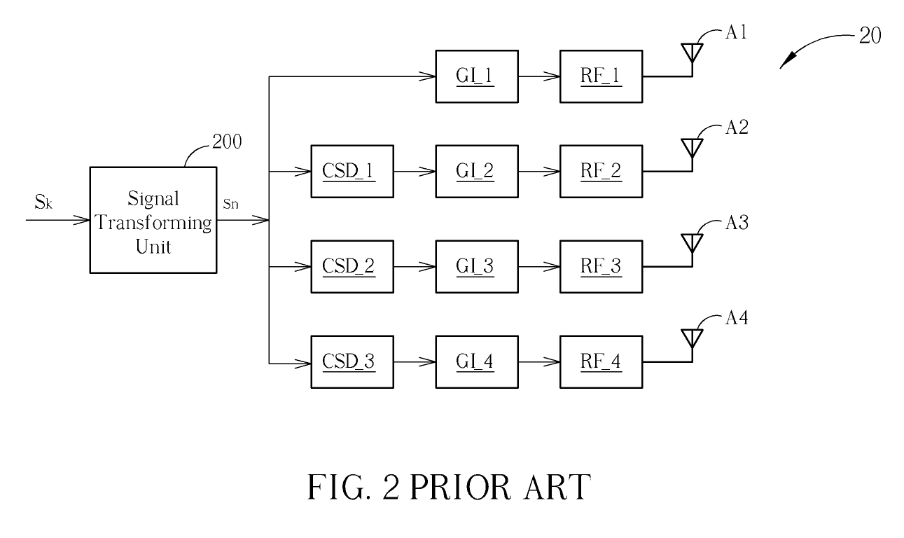

The signal transforming unit 304 is coupled to the phase adjusting unit 302, and operation of the signal transforming unit 304 is similar to the signal transforming unit 200 of the transmitter 20 shown in FIG. 2 for performing inverse discrete Fourier transform, to transform the frequency-domain preamble sequence {Sₖ=(j)^{└k/64┘}S_{k mod 64}, K=0, 1, . . . , 255} into a time-domain preamble sequence {sₙ, n=0, 1, . . . , 255}, which is an OFDM symbol. The inverse discrete Fourier transform done by the signal transforming unit 304 are represented as

$${s}_{n} = {\sum }_{k = 0}^{255} {S}_{k} {e}^{j \frac{2 π}{256} kn} . \qquad ( 2 )$$

Based on the equation 1 and the equation 2, it can be derived that

$$\begin{matrix}{s}_{n} = {\sum }_{k = 0}^{255} {S}_{k} {e}^{j \frac{2 π}{256} kn} \\ = {\sum }_{k = 0}^{63} {S}_{k} \cdot ( {e}^{j \frac{2 π}{256} kn} + {e}^{j \frac{π}{2}} \cdot {e}^{j \frac{2 π}{256} ( k + 64 ) n} + {e}^{jπ} \cdot {e}^{j \frac{2 π}{256} ( k + 128 )} + \\ {e}^{j \frac{3 π}{2}} \cdot {e}^{j \frac{2 π}{256} ( k + 192 ) n} ) \\ = {\sum }_{k = 0}^{63} {S}_{k} \cdot ( 1 + {e}^{j \frac{π}{2} ( n + 1 )} + {e}^{jπ ( n + 1 )} + {e}^{j \frac{3 π}{2} ( n + 1 )} ) \cdot {e}^{j \frac{2 π}{256} kn}\end{matrix} \qquad ( 3 )$$

Based on the equation 3, when the remainder of the sampling time n modulo 4 is equal to 0, 1, 2, and 3,

$$( 1 + {e}^{j \frac{π}{2} ( n + 1 )} + {e}^{jπ ( n + 1 )} + {e}^{j \frac{3 π}{2} ( n + 1 )} ) is equal to n = 0 : \\ \begin{matrix}( 1 + {e}^{j \frac{π}{2} ( n + 1 )} + {e}^{jπ ( n + 1 )} + {e}^{j \frac{3 π}{2} ( n + 1 )} ) = ( 1 + {e}^{j \frac{π}{2}} + {e}^{jπ} + {e}^{j \frac{3 π}{2}} ) \\ = 0\end{matrix} \\ n = 1 : \\ \begin{matrix}( 1 + {e}^{j \frac{π}{2} ( n + 1 )} + {e}^{jπ ( n + 1 )} + {e}^{j \frac{3 π}{2} ( n + 1 )} ) = ( 1 + {e}^{jπ} + {e}^{j2π} + {e}^{j3π} ) \\ = 0\end{matrix} \\ n = 2 : \\ \begin{matrix}( 1 + {e}^{j \frac{π}{2} ( n + 1 )} + {e}^{jπ ( n + 1 )} + {e}^{j \frac{3 π}{2} ( n + 1 )} ) = ( 1 + {e}^{j \frac{3 π}{2}} + {e}^{j4π} + {e}^{j \frac{9 π}{2}} ) \\ = 0\end{matrix} \\ n = 3 : \\ \begin{matrix}( 1 + {e}^{j \frac{π}{2} ( n + 1 )} + {e}^{jπ ( n + 1 )} + {e}^{j \frac{3 π}{2} ( n + 1 )} ) = ( 1 + {e}^{j2π} + {e}^{j4π} + {e}^{j6π} ) \\ = 4\end{matrix} \qquad ( 4 )$$

The equation 4 can also be represented as

$$( 1 + {e}^{j \frac{π}{2} ( n + 1 )} + {e}^{jπ ( n + 1 )} + {e}^{j \frac{3 π}{2} ( n + 1 )} ) = \{ \begin{matrix}0 , & if n mod4 = 0 , 1 , 2 \\ 4 , & if n mod 4 = 3\end{matrix} \qquad ( 5 )$$

From the equation 3 and the equation 5, it is known that ¾ of the time-domain preamble sequence {sₙ, n=0, 1, . . . , 255} generated by the signal transforming unit 304 are zeros, which causes a large peak-average power ratio (PAPR). The PAPR adjusting unit 306 is utilized for reducing the PAPR of the time-domain preamble sequence {sₙ, n=0, 1, . . . , 255}.

Each of the CSD processing units CSDA_1-CSDA_4 in the PAPR adjusting unit 306 is coupled to the signal transforming unit 304 and a corresponding one of the multiplexers M1-M4, and is utilized for performing a cyclic shift delaying process on the time-domain preamble sequence sₙ by using a time delay so as to generate a delayed time-domain preamble sequence, and the CSD processing units CSDA_1-CSDA_4 generate delayed time-domain preamble sequences s⁽¹⁾, s⁽²⁾, s⁽³⁾, and s⁽⁴⁾ respectively. Time delays used by the CSD processing units CSDA_1-CSDA_4 are different, which are denoted as 4m₁, 4m₂+1, 4m₃+2, and 4m₄+3, wherein m₁, m₂, m₃, and m₄ are equal or different integers. The values of 4m₁, 4m₂₊1, 4m₃+2, and 4m₄+3 are not unique and can be set upon requirements. According to the equation 2, the delayed time-domain preamble sequences generated by the CSD processing units CSDA_1-CSDA_4 are

$${s}^{( 1 )} = {\sum }_{k = 0}^{255} {S}_{k} {e}^{j \frac{2 π}{256} k ( n + 4 {m}_{1} )} , \\ {s}^{( 2 )} = {\sum }_{k = 0}^{255} {S}_{k} {e}^{j \frac{2 π}{256} k ( n + 4 {m}_{2} + 1 )} , \\ {s}^{( 3 )} = {\sum }_{k = 0}^{255} {S}_{k} {e}^{j \frac{2 π}{256} k ( n + 4 {m}_{3} + 2 )} , \\ and$$

$${s}^{( 4 )} = {\sum }_{k = 0}^{255} {S}_{k} {e}^{j \frac{2 π}{256} k ( n + 4 {m}_{4} + 3 )} ,$$

respectively. The multiplexers M1-M4 and the adder 310 are utilized for normalization to make total transmit power of the time-domain preamble sequences s⁽¹⁾, s⁽²⁾, s⁽³⁾, and s⁽⁴⁾ are identical to the transmit power of the time-domain preamble sequence sₙ before the cyclic shift delaying process is performed. In detail, each of the multiplexers M1-M4 is utilized for multiplying a corresponding one of the time-domain preamble sequences s⁽¹⁾, s⁽²⁾, s⁽³⁾, and s⁽⁴⁾ by a corresponding one of normalization factors p₁, p₂, p₃, and p₄, respectively, as shown in FIG. 3, to generate a multiplication result. The normalization factors p₁, p₂, p₃, and p₄ are not limited to specific values. The adder 310 is coupled to the multiplexers M1-M4, and is utilized for adding all of multiplication results generated by the multiplexers M1-M4 to generate a time-domain preamble sequence {s′ₙ=p₁s⁽¹⁾+p₂s⁽²⁾+p₃s⁽³⁾+p₄s⁽⁴⁾, n=0, 1, . . . , 255}. Through the PAPR adjusting unit 306, the number of zeros in the time-domain preamble sequences s′ₙ is much less than the number of zeros in the preamble sequence sₙ outputted by the signal informing unit 304, and the PAPR of the time-domain preamble sequence s′ₙ are considerably reduced.

Next, the time-domain preamble sequence s′ₙ passes through the CSD processing units CSD_1-CSD_3 and the GI processing units GI_1-GI_4 in transmit chains that perform signal processing to resist multipath interference and inter-symbol interference, and is converted into RF signals by the RF signal processing units RF_1-RF_4, and are transmitted to the air by the antennas A1-A4. Operations of transmit chains in the transmitter 30 is similar to that in the transmitter of IEEE 802.11a/g/n standard, which are well known to those skilled in the art and omitted herein.

In the transmitter 20 of IEEE 802.11n standard in FIG. 2, after a 20 MHz or 40 MHz preamble sequence is transformed into a time-domain preamble sequence, the time-domain preamble sequence is then outputted to transmit chains to be processed. In comparison, in the transmitter 30 of IEEE 802.11ac standard, before the 80 MHz preamble sequence Sₖ being transformed into a time-domain preamble sequence through the signal transforming unit 304, higher three 20 MHz portions of the 80 MHz preamble sequence Sₖ are phase-rotated respectively through the phase adjusting unit 302 such that the 80 MHz preamble sequence of FIG. 4 is generated. In addition, the time-domain preamble sequence sₙ outputted from the signal transforming unit 304 is further processed through the PAPR adjusting unit 306 to reduce the PAPR. As a result, the 80 MHz preamble sequence according to the present invention is backward compatible to IEEE 802.11a/g/n standard, and the PAPR of the transmitted time-domain preamble sequence s′ₙ is reduced.

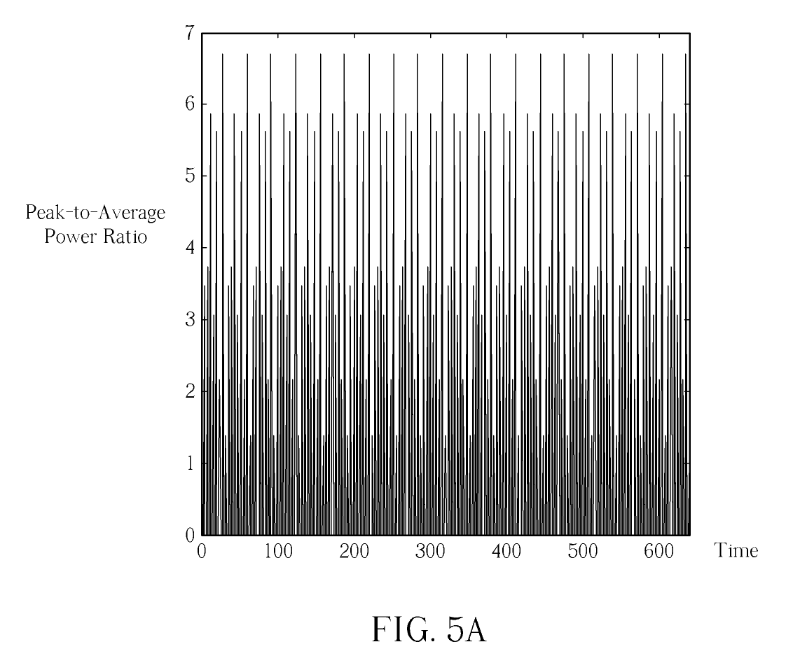

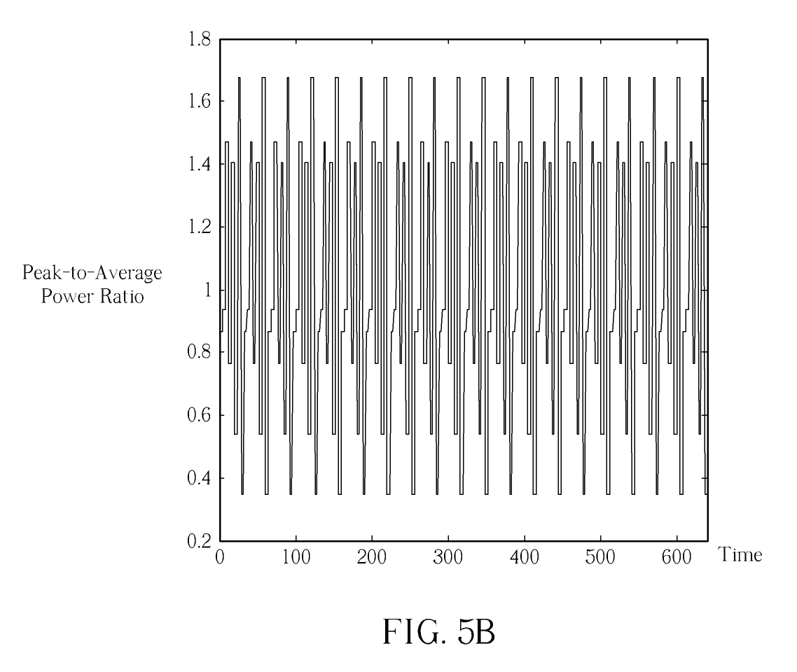

Pleaser refer FIG. 5A and FIG. 5B. FIG. 5A is a diagram of the PAPR of the time-domain preamble sequence generated by the signal transforming unit 304 of the transmitter 30 which does not include the PAPR adjusting unit 306. As can be seen in FIG. 5A, the maximum PAPR approaches 7. FIG. 5B is a diagram of the PAPR of the time-domain preamble sequence generated by the PAPR adjusting unit 306 of the transmitter 30, wherein the time delays used by the CSD processing units CSDA_1-CSDA_4 are set based on m₁₌ₘ₂=m₃=m₄=0 and the normalization factors used by the multiplexers M1-M4 are

$${p}_{1} = {p}_{2} = {p}_{3} = {p}_{4} = \sqrt{\frac{1}{4}} .$$

As can be seen in FIG. 5B, the maximum PAPR approaches 1.8, which is obviously lower than the maximum PAPR shown in FIG. 5A. That is to say, using the PAPR adjusting unit 306 in a transmitter can reduce PAPR of the transmitted time-domain preamble sequence.

The transmitter 30 of FIG. 3 is only one of embodiments of the present invention, and those skilled in the art can make alterations and modifications accordingly. For example, the phase adjusting unit 302 can also perform phase rotation on the 80 MHz preamble sequence by using phase rotation angles other than that represented by (0, j, −1, -j) shown in FIG. 4, so as to generate an 80 MHz preamble not equal to that in FIG. 4. Based on the above situation, the number of zeros in a time-domain preamble sequence transformed from the 80 MHz preamble may not be the same as illustrated in the equation 3 and the equation 4, and the PAPR adjusting unit 306 may require different number of CSD processing units and corresponding multiplexers to realize PAPR reduction, which is not limited to 4 as in FIG. 4.

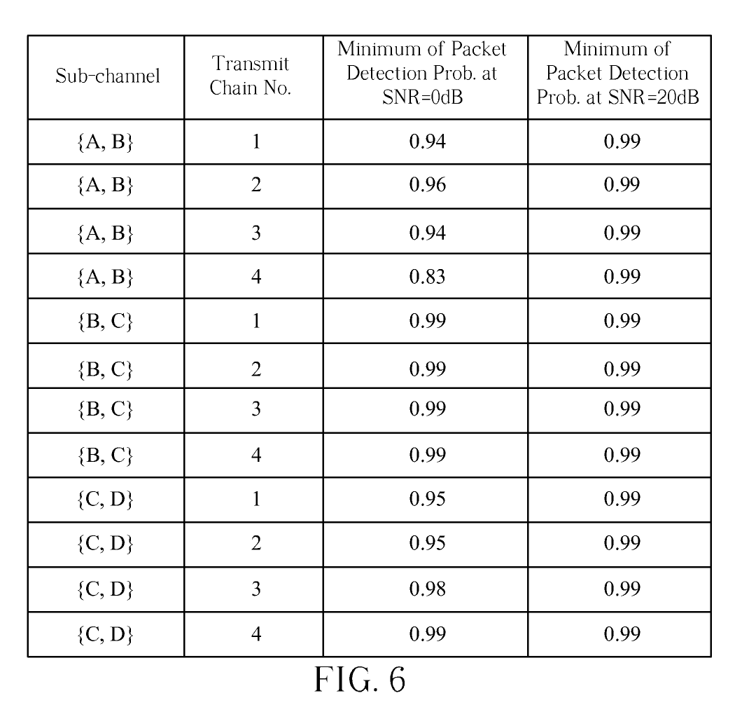

In order to verify whether receivers in the WLAN system are capable of correctly detecting the preamble of the present invention, a simulation is performed by the transmitter 30 based on a channel model B of IEEE 802.11n standard. The transmitter 30 transmits 1000 packets only including the 80MHz preamble sequence of FIG. 4, and a 40 MHz receiver and an 80 MHz receiver receive the 1000 packets and calculate packet detection probability respectively, as listed in FIG. 6-FIG. 9. Note that the 80 MHz channel can be divided into four non-overlapping 20 MHz sub-channels, denoted as A, B, C, and D from the lowest to the highest, and the 80 MHz channel can also be divided into three partially overlapping 40 MHz sub-channels {A, B}, {B, C}, and {C, D}.

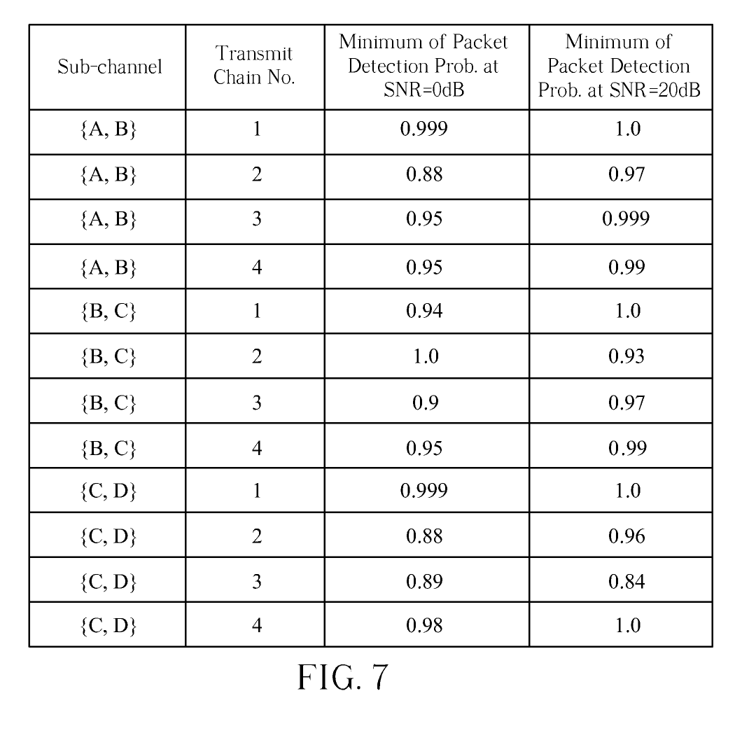

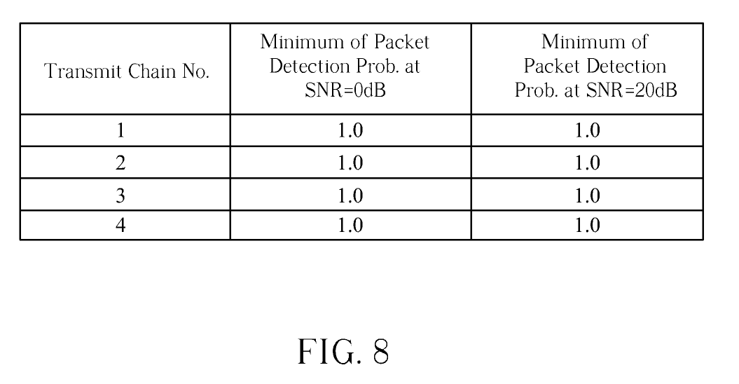

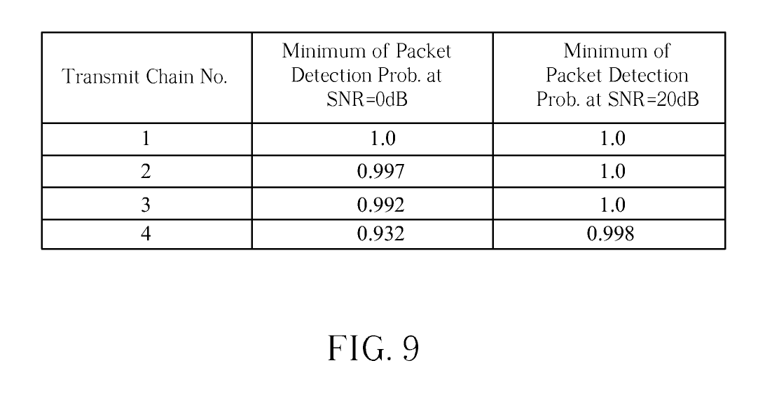

Please refer to FIG. 6. In FIG. 6, the minimum values of the packet detection probability under different signal-to-noise ratio (SNR) by 40 MHz sub-channels {A, B}, {B, C}, {C, D}, and each transmit chain, measured by an auto-correlation detector of a 40 MHz receiver, are listed. Please refer to FIG. 7. In FIG. 7, the minimum values of the packet detection probability under different SNR by 40 MHz sub-channels {A, B}, {B, C}, {C, D} and each transmit chain, measured by a cross-correlation detector of a 40 MHz receiver, are listed. It can be seen from FIG. 6 and FIG. 7 that most of the minimum values of the packet detection probability measured by the 40 MHz receiver are larger than 90%, which indicates that even the 40 MHz receiver does not support IEEE 802.11ac standard, the 40 MHz receiver can still detect the 80 MHz preamble sequence generated by the transmitter 30 successfully. Please refer to FIG. 8. In FIG. 8, the minimum values of the packet detection probability under different SNR by each transmit chain, measured by an auto-correlation detector of an 80 MHz receiver, are listed. Please refer to FIG. 9. In FIG. 9, the minimum values of the packet detection probability under different SNR by each transmit chain, measured by a cross-correlation detector of an 80 MHz receiver, are listed. It can be seen from FIG. 8 and FIG. 9 that most of the minimum values of the packet detection probability measured by the 80 MHz receiver reach up to 100%, which indicates that the 80 MHz preamble sequence generated by the transmitter 30 can be detected by the 80 MHz receiver successfully.

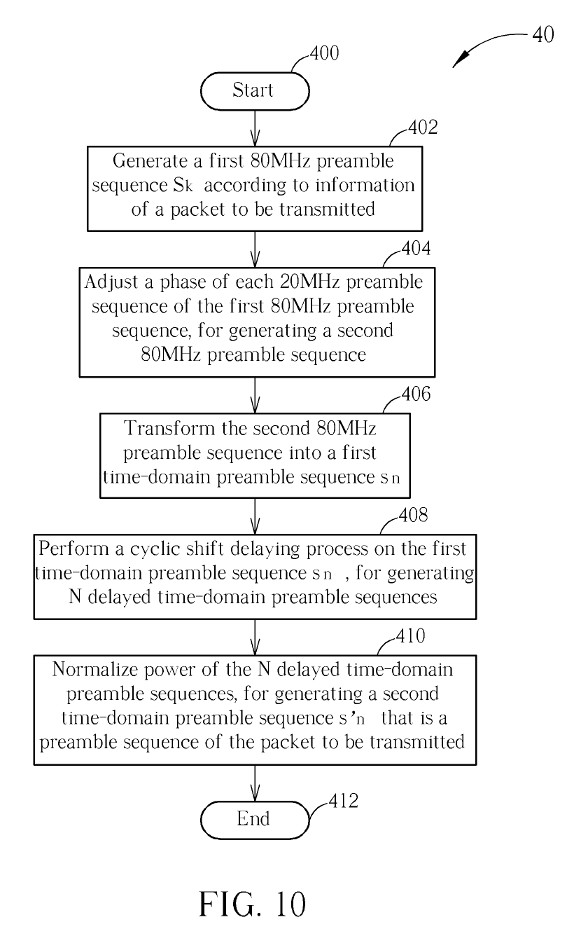

The sequence generating unit 300, the phase adjusting unit 302, the signal transforming unit 304, and the PAPR adjusting unit 306 of the transmitter 30 are operated according to a process, to generate the time-domain preamble sequence that is outputted to the transmit chains. Please refer to FIG. 10, which is a flowchart of a process 40 according to an embodiment of the present invention. The process 40 is utilized in a transmitter of IEEE 802.11ac standard, such as transmitter 30 of FIG. 3, for generating a time-domain preamble sequence corresponding to an 80 MHz channel, which is the preamble sequence of a transmitted packet. The process 40 comprises the following steps:

Step 400: Start.

Step 402: Generate a first 80 MHz preamble sequence Sₖ according to information of a packet to be transmitted.

Step 404: Adjust a phase of each 20 MHz preamble sequence of the first 80 MHz preamble sequence, for generating a second 80 MHz preamble sequence.

Step 406: Transform the second 80 MHz preamble sequence into a first time-domain preamble sequence sₙ.

Step 408: l Perform a cyclic shift delaying process on the first time-domain preamble sequence sₙ, for generating N delayed time-domain preamble sequences.

Step 410: Normalize power of the N delayed time-domain preamble sequences, for generating a second time-domain preamble sequence s′ₙ that is a preamble sequence of the packet to be transmitted.

Step 412: End.

Please refer to the abovementioned transmitter 30 for understanding detailed operation of the process 40, which is not repeated herein. The sequence generating unit 300 is operated according to Step 402. The phase adjusting unit 302 is operated according to Step 404, which can be represented as the equation 1, and the four phase rotation angles corresponding to the four sub-channels from the lowest to the highest are 0°, 90°, 180°, and 270° respectively, hence the 80 MHz preamble sequence is backward compatible to IEEE 802.11a/g/n standard. The signal transforming unit 304 is operated according to Step 406, which can be represented as the equation 2. The CSD processing units CSDA_{—1-CSDA}_4 of the PAPR adjusting unit 306 are operated according to Step 408. As a result of phase rotation done by the phase adjusting unit 302, the PAPR adjusting unit 306 uses four different time delays to perform the cyclic delaying process on the first time-domain preamble sequence sₙ to generate the four delayed preamble sequences of s⁽¹⁾, s⁽²⁾, s⁽³⁾, s⁽⁴⁾ in order to reduce the PAPR of the first time-domain preamble sequence sₙ. The multiplexers M1-M4 and the adder 310 are operated according to Step 410 to generate the second time-domain preamble sequence s′ₙ, which leads to a lower PAPR.

Note that the process 40 is not limited to be used in the transmitter 30; any transmitter with appropriate units can use the process 40 to generate the 80 MHz preamble sequence that leads to a lower PAPR. The phase rotation angles used in Step 404 are not limited to specific angles. Based on the angles used in Step 404, a specific number of cyclic shift delaying processes are therefore required to reduce PAPR of the first time-domain preamble sequence sₙ.

In conclusion, according to the preamble sequence generating device and the method of the generating preamble sequence of IEEE 802.11ac standard according to the present invention, each 20 MHz preamble sequence of the entire 80 MHz preamble sequence is rotated by an appropriate angle such that the 80 MHz preamble sequence is backward compatible to IEEE 802.11a/g/n standard; and after the 80MHz preamble sequence is transformed into the time-domain preamble sequence, through the cyclic shift delaying process, the PAPR of the time-domain preamble sequence is reduced, which is also leads to a higher quality of packet transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of generating a preamble sequence of a packet comprising:
generating a first frequency-domain preamble sequence according to information of the packet, the first frequency-domain preamble sequence comprising a plurality of subsequences corresponding to a plurality of sub-channels;
adjusting a phase of each subsequence of the first frequency-domain preamble sequence, for generating a second frequency-domain preamble sequence;
transforming the second frequency-domain preamble sequence into a first time-domain preamble sequence;
performing a cyclic shift delaying process on the first time-domain preamble sequence, for generating a plurality of delayed time-domain preamble sequences; and
normalizing power of the plurality of delayed time-domain preamble sequences, for generating a second time-domain preamble sequence that is a preamble sequence of the packet.

2. The method of claim 1, wherein the step of generating the first frequency-domain preamble sequence according to information of the packet comprises:
generating a frequency-domain preamble sequence corresponding to the lowest one of the plurality of sub-channels according to information of the packet; and
making replicas of the frequency-domain preamble to form frequency-domain preambles corresponding to sub-channels other than the lowest sub-channel, for generating the first frequency-domain preamble sequence.

3. The method of claim 1, wherein the step of adjusting the phase of each subsequence of the first frequency-domain preamble sequence is adjusting the phase of each subsequence of the first frequency-domain preamble based on a plurality of phase rotation angles corresponding to the plurality of sub-channels.

4. The method of claim 3, wherein the number of the plurality of sub-channels are 4, and the plurality of phase rotation angles are 0°, 90°, 180°, and 270° corresponding to the plurality of sub-channels from the lowest to the highest.

5. The method of claim 1, wherein the step of performing the cyclic shift delaying process on the first time-domain preamble sequence is performing the cyclic shift delaying process on the first time-domain preamble sequence by using a plurality of different time delays.

6. The method of claim 1, wherein the step of normalizing power of the plurality of delayed time-domain preamble sequences is normalizing power of the plurality of delayed time-domain preamble sequences by using a plurality of equivalent normalization factors.

7. A wireless device comprising:
a sequence generating unit for generating a first frequency-domain preamble sequence according to information of the packet, the first frequency-domain preamble sequence comprising a plurality of subsequences corresponding to a plurality of sub-channels;
a phase adjusting unit for adjusting a phase of each subsequence of the first frequency-domain preamble sequence, for generating a second frequency-domain preamble sequence;
a signal transforming unit for transforming the second frequency-domain preamble sequence into a first time-domain preamble sequence; and
a peak-to-average power ratio (PAPR) adjusting unit for reducing the PAPR of the first time-domain preamble sequence, for generating a second time-domain preamble sequence that is a preamble sequence of the packet.

8. The wireless device of claim 7, wherein the sequence generating unit generates a frequency-domain preamble sequence corresponding to the lowest one of the plurality of sub-channels according to information of the packet, and makes replicas of the frequency-domain preamble to form frequency-domain preambles corresponding to sub-channels other than the lowest sub-channel, for generating the first frequency-domain preamble sequence.

9. The wireless device of claim 7, wherein the phase adjusting unit adjusts the phase of each subsequence of the first frequency-domain preamble based on a plurality of phase rotation angles corresponding to the plurality of sub-channels.

10. The wireless device of claim 7, wherein the number of the plurality of sub-channels are 4, and the plurality of phase rotation angles are 0°, 90°, 180°, and 270° corresponding to the plurality of sub-channels from the lowest to the highest.

11. The wireless device of claim 7, wherein the PAPR adjusting unit comprises:
a plurality of cyclic shift delay (CSD) processing units coupled to the signal transforming unit, each CSD processing unit for performing a cyclic shift delaying process on the first time-domain preamble sequence, for generating a plurality of delayed time-domain preamble sequences;
a plurality of multiplexers, each multiplexer for multiplying one of the plurality of delayed time-domain preamble sequences by a corresponding one of a plurality of normalization factors, for generating a plurality of multiplication results; and
an adder for adding the plurality of multiplication results, for generating the second time-domain preamble sequence.

12. The wireless device of claim 11, wherein the plurality of CSD processing units perform the cyclic shift delaying process on the first time-domain preamble sequence by using a plurality of different time delays, for generating the plurality of delayed time-domain preamble sequences.

13. The wireless device of claim 11, wherein the plurality of normalization factors are equivalent.
